(19) United States
(12) Patent Application Publication
(10) Pub. No.: US 2011/0088799 A1
(43) Pub. Date: Apr. 21, 2011

(54) Digital faucet system

(76) Inventor: Woo-Chong Jung, Seoul (KR)

(21) Appl. No.: 12/588,425

(22) Filed: Oct. 15, 2009

(51) Int. Cl. F16K 21/00

(52) U.S. Cl. 137/607

(57) ABSTRACT

A digital faucet system includes a faucet, data input unit, a sense unit, an adjusting unit and a control unit. The data input unit includes a display panel for displaying a temperature and a flow rate of mixed water from the faucet, and a touch screen for generating temperature input data and flow rate input data. The sense unit generates temperature sensing data and flow rate sensing data by detecting the temperature and the flow rate of the mixed water. The adjusting unit adjusts the temperature and the flow rate of the mixed water. The control unit controls the adjusting unit to adjust the temperature and the flow rate of the mixed water based on the temperature input data, the flow rate input data, the temperature sensing data and the flow rate sensing data. The temperature and the flow rate of the mixed water may be automatically and simultaneously adjusted.

### BACKGROUND

1. Technical Field

Example embodiments relate to a faucet system, and more particularly to a digital faucet system automatically adjusting temperature and flow rate of water based on input data.

2. Description of the Related Art

A faucet installed in a bathtub, a sink, a washstand, and the like, supplies water to a user. The faucet includes a handle or a lever for adjusting the intensity of water supplied by the faucet. The faucet may be classified into a single handle faucet, a double handle faucet, and a single lever faucet.

FIG. 1 is a diagram illustrating a conventional single handle faucet.

Referring to FIG. 1, a single handle faucet 100 includes a handle 110 and a washer 120. A user may rotate the handle 110 counterclockwise so that water is supplied by the faucet 100. The user may rotate the handle 110 clockwise so that water is not supplied by the faucet 100. When the handle 110 rotates counterclockwise, the washer 120 moves up, and thus the water is supplied. When the handle 110 rotates clockwise, the washer 120 moves down, and thus the water is not supplied. The conventional single handle faucet 100 is rarely used since the conventional single handle faucet 100 can supply either hot water or cold water.

FIG. 2 is a diagram illustrating a conventional double handle faucet.

Referring to FIG. 2, the double handle faucet 200 includes a hot water handle 210 and a cold water handle 220. A user may rotate the hot water handle 210 counterclockwise so that the hot water is supplied, and rotate the cold water handle 220 counterclockwise so that the cold water is supplied. The user may rotate the hot water handle 210 clockwise so that the hot water is not supplied, and rotate the cold water handle 220 clockwise so that the cold water is not supplied. To set the water supplied by the double handle faucet 200 to desired temperature, the user should rotate the hot water handle 210 and the cold water handle 220 and check the temperature by hand until the temperature of the mixed water becomes the desired temperature. Further, although the temperature of the water is the desired temperature, the user should adjust the intensity of the hot water and that of the cold water by rotating the hot water handle 210 and the cold water handle 220 if the intensity of the water supplied by the double handle faucet 200 is not desirable.

FIG. 3 is an exploded perspective view of a conventional single lever faucet.

Referring to FIG. 3, a single lever faucet 300 includes a lever 310, a connecting bolt 320, a cartridge 330 and a main body 340. The lever 310 is movable up, down, left and right. When the lever 310 moves up or down, mixed hot and cold water may be supplied or not be supplied. When the lever 310 moves left or right, a ratio of hot water to cold water may be adjusted. The connecting bolt 320 and the cartridge 330 fixed to the main body 330 by the connecting bolt 320 may connect the lever 310 to the main body 340. A user should move the lever 310 and check the temperature by hand until the temperature of the water becomes the desired temperature. Further, although the temperature or the intensity of the water suddenly changes, the user can not notice the sudden change.

As described above, in the single handle faucet 100, the double handle faucet 200 and the single lever faucet 300, there is a problem that the user should manually move the handle to adjust the temperature and/or the intensity of the water. Further, if the user does not close the handle or the lever before leaving the faucet, a quantity of water may be wasted. To overcome such a problem, an automatic faucet for detecting an approach of a human body has been developed.

FIG. 4 is a perspective view of a conventional automatic faucet.

Referring to FIG. 4, an automatic faucet 400 includes a body unit 410, an outlet 420, a temperature adjusting unit 430 and an approach sensor 440. The automatic faucet 400 is coupled to a hot water path 450 and a cold water path 460.

The temperature adjusting unit 430 may move in a first direction to adjust a ratio of hot water to cold water. The temperature adjusting unit 430 may move in a second direction perpendicular to the first direction to adjust an intensity of water. If the approach sensor 440 detects an approach of a human body, the water may be supplied from the outlet 420.

Even through the turn-on or the turn-off of the automatic faucet 400 is automatically controlled, a user should manually adjust the temperature adjusting unit 430 to set the temperature and/or the intensity.

A conventional faucet requires manual handle for adjusting the temperature and the intensity of the water. Further, the handle included in the conventional faucet may deteriorate an appearance of the faucet.

### SUMMARY

Example embodiments provide a digital faucet system automatically and simultaneously adjusting temperature and flow rate of water based on temperature input data and flow rate input data, and having an excellent appearance.

According to some example embodiments, a digital faucet system includes a faucet, a data input unit, a sense unit, an adjusting unit and a control unit.

The faucet is coupled to a hot water path and a cold water path, and outputs mixed water including hot water provided from the hot water path and cold water provided from the cold water path. The data input unit includes a display panel for displaying temperature and flow rate of the mixed water, and a touch screen for generating temperature input data and flow rate input data. The sense unit generates temperature sensing data and flow rate sensing data by detecting the temperature and the flow rate of the mixed water. The adjusting unit adjusts the temperature and the flow rate of the mixed water. The control unit controls the adjusting unit to adjust the temperature and the flow rate of the mixed water based on the temperature input data, the flow rate input data, the temperature sensing data and the flow rate sensing data.

In some embodiments, the adjusting unit may include a hot water adjusting unit configured to adjust flow rate of the hot water, and a cold water adjusting unit configured to adjust flow rate of the cold water.

When the temperature corresponding to the temperature input data is different from the temperature corresponding to the temperature sensing data, the control unit may control the hot water adjusting unit and the cold water adjusting unit to adjust a ratio of the flow rate of the hot water to the flow rate of the cold water while the flow rate of the mixed water is maintained. When the flow rate corresponding to the flow rate input data is different from the flow rate corresponding to the flow rate sensing data, the control unit may control the hot water adjusting unit and the cold water adjusting unit to adjust the flow rate of the hot water and the flow rate of the cold water while a ratio of the flow rate of the hot water to the flow rate of the cold water is maintained.

In some embodiments, the control unit may provide image data corresponding to the temperature sensing data and the flow rate sensing data to the data input unit, and the data input unit may display an image based on the image data. The image displayed by the data input unit may include information about both of the temperature and the flow rate of the mixed water currently supplied by the faucet.

In some embodiments, the touch screen may generate the temperature input data and the flow rate input data by detecting a single touch point.

According to some example embodiments, a digital faucet system includes a faucet, a data input unit, an adjusting unit and a control unit.

The faucet is coupled to a hot water path and a cold water path, and outputs mixed water including hot water provided from the hot water path and cold water provided from the cold water path. The data input unit generates temperature input data and flow rate input data. The adjusting unit adjusts temperature and flow rate of the mixed water. The control unit controls the adjusting unit to adjust the temperature and the flow rate of the mixed water based on the temperature input data and the flow rate input data.

In some embodiments, the data input unit may include a touch screen for detecting a touch point that indicates temperature and flow rate of the mixed water to be set.

In some embodiments, the data input unit may include a panel including image pixels for displaying an image that represents the temperature and the flow rate of the mixed water and touch screen sensors for detecting a touch point that indicates temperature and flow rate of the mixed water to be set, and a driver integrated circuit configured to drive the panel by applying voltages corresponding to image data provided from the control unit to the image pixels, configured to generate the temperature input data and the flow rate input data based on detection result from the touch screen sensors, and configured to provide the temperature input data and the flow rate input data to the control unit.

In some embodiments, the adjusting unit may include a hot water adjusting unit configured to adjust flow rate of the hot water, and a cold water adjusting unit configured to adjust flow rate of the cold water.

The hot water adjusting unit and the cold water adjusting unit may adjust a ratio of the flow rate of the hot water to the flow rate of the cold water so as to adjust the temperature of the mixed water. The hot water adjusting unit and the cold water adjusting unit may adjust the flow rate of the hot water and the flow rate of the cold water and maintain a ratio of the flow rate of the hot water to the flow rate of the cold water so as to adjust the flow rate of the mixed water.

In some embodiments, the digital faucet system may further include a sense unit configured to generate temperature sensing data and flow rate sensing data by detecting the temperature and the flow rate of the mixed water, and provide the temperature sensing data and the flow rate sensing data to the control unit.

In some embodiments, the control unit may provide image data corresponding to the temperature sensing data and the flow rate sensing data, and the data input unit may display an image based on the image data.

In some embodiments, the control unit may control the adjusting unit to adjust the temperature of the mixed water when the temperature corresponding to the temperature input data is different from the temperature corresponding to the temperature sensing data, and the control unit may control the adjusting unit to adjust the flow rate of the mixed water when the flow rate corresponding to the flow rate input data is different from the flow rate corresponding to the flow rate sensing data.

In some embodiments, the adjusting unit may include a hot water adjusting unit for adjusting flow rate of the hot water and a cold water adjusting unit for adjusting flow rate of the cold water, the control unit may control the hot water adjusting unit and the cold water adjusting unit based on the temperature input data and the temperature sensing data to adjust a ratio of the flow rate of the hot water to the flow rate of the cold water, and the control unit may control the hot water adjusting unit and the cold water adjusting unit based on the flow rate input data and the flow rate sensing data to adjust the flow rate of the hot water and the flow rate of the cold water.

In some embodiments, the sense unit may include a mixed water temperature sensor installed in a mixed water path through which the mixed water flows, and configured to generate the temperature sensing data by detecting the temperature of the mixed water, and a mixed water flow rate sensor installed in the mixed water path, and configured to generate the flow rate sensing data by detecting the flow rate of the mixed water.

In some embodiments, the sense unit may include a hot water temperature sensor installed in the hot water path, and configured to generate hot water temperature sensing data by detecting temperature of the hot water, a cold water temperature sensor installed in the cold water path, and configured to generate cold water temperature sensing data by detecting temperature of the cold water, a hot water flow rate sensor installed in the hot water path, and configured to generate hot water flow rate sensing data by detecting flow rate of the hot water, and a cold water flow rate sensor installed in the cold water path, and configured to generate cold water flow rate sensing data by detecting flow rate of the cold water.

According to some example embodiments, a digital faucet system may automatically and simultaneously adjust temperature and flow rate of water based on temperature input data and flow rate input data. Further, according to some example embodiments, a digital faucet system may have an excellent appearance.

### BRIEF DESCRIPTION OF THE DRAWINGS

Illustrative, non-limiting example embodiments will be more clearly understood from the following detailed description taken in conjunction with the accompanying drawings.

FIG. 1 is a diagram illustrating a conventional single handle faucet.

FIG. 2 is a diagram illustrating a conventional double handle faucet.

FIG. 3 is an exploded perspective view of a conventional single lever faucet.

FIG. 4 is a perspective view of a conventional automatic faucet.

FIG. 5 is a diagram illustrating an appearance of a digital faucet system according to some example embodiments.

FIG. 6 is a block diagram illustrating a digital faucet system according to some example embodiments.

FIG. 7 is a diagram illustrating a faucet included in the digital faucet system 1000 of FIG. 5.

FIG. 8 is a cross-sectional view of the faucet of FIG. 5.

FIG. 9 is a block diagram illustrating a data input unit included in the digital faucet system of FIG. 5.

FIGS. 10A through 10E are diagrams illustrating appearances of examples of a data input unit included in the digital faucet system of FIG. 5.

FIGS. 11A through 11C are diagrams illustrating examples of a temperature sensor included in the digital faucet system of FIG. 5.

FIGS. 12A and 12B are diagrams illustrating examples of a flow rate sensor included in the digital faucet system of FIG. 5.

FIGS. 13A and 13B are diagrams illustrating an example of an adjusting unit included in the digital faucet system of FIG. 5.

FIG. 14 is a diagram illustrating an appearance of a digital faucet system according to some example embodiments.

FIG. 15 is a diagram illustrating an appearance of a digital faucet system according to some example embodiments.

FIG. 16 is a diagram illustrating an appearance of a digital faucet system according to some example embodiments.

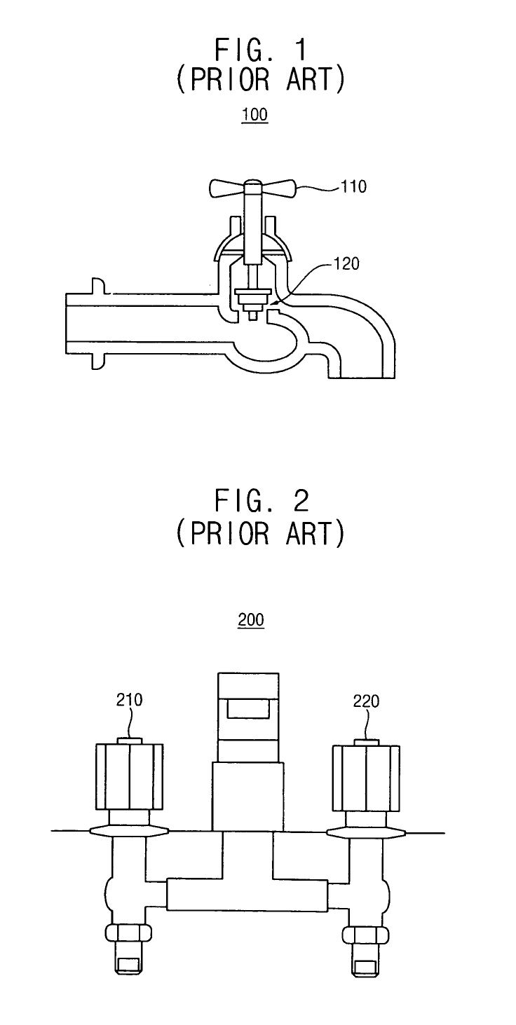

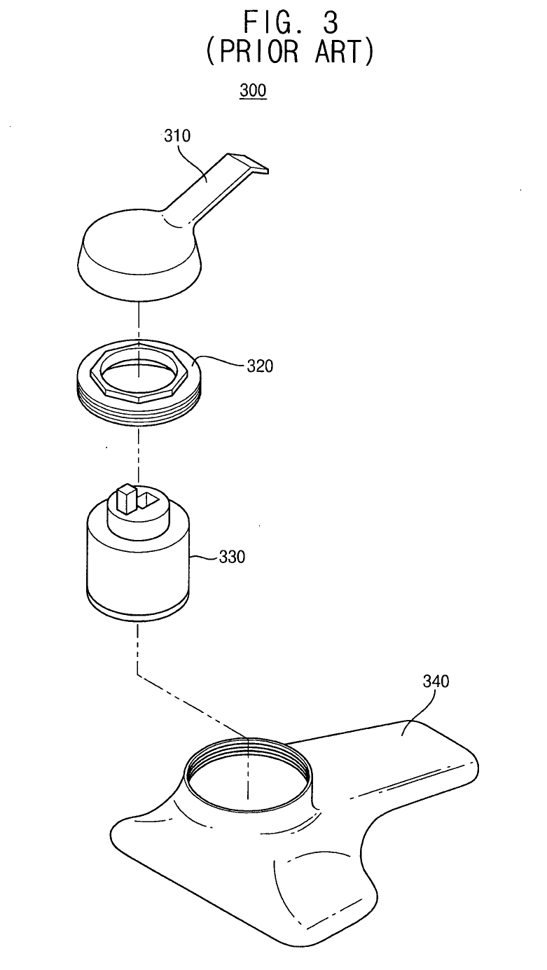

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

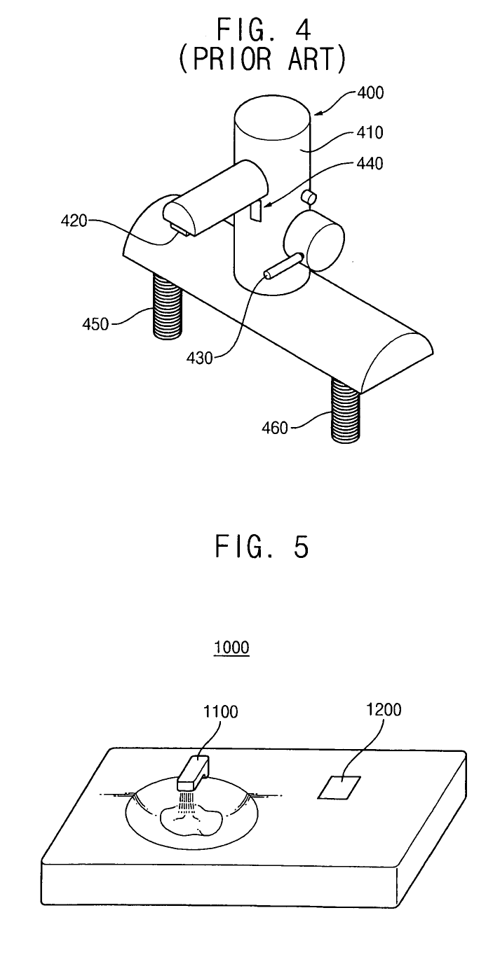

FIG. 5 is a diagram illustrating an appearance of a digital faucet system according to some example embodiments.

Referring to FIG. 5, a digital faucet system 1000 includes a faucet (i.e., a water tap) 1100 and a data input unit 1200.

The data input unit 1200 generates temperature input data and flow rate input data by detecting a user's input. The data input unit 1200 may include at least one touch screen. The touch screen included in the data input unit 1200 may have a two-dimensional plane shape or a one-dimensional bar shape. In some embodiments, the data input unit 1200 may include at least one touch screen having the plane shape and at least one touch screen having the bar shape. The data input unit 1200 may further include a display panel for displaying an image. In some embodiments, the touch screen may be formed on the display panel. In other embodiments, the touch screen and the display panel are formed in the same plane. The data input unit 1200 may further include a waterproof layer for protect the touch screen from water. The data input unit 1200 may further include an on/off button. For example, the on/off button may be a mechanical button, a portion of the touch screen or an electronic button in which a piezoelectric element is embedded.

The digital faucet system 1000 may supply mixed water including hot water and/or cold water through the faucet 1100 based on the temperature input data and the flow rate input data generated by the data input unit 1200. The faucet 1100 may not have a mechanical handle for manually adjusting temperature and flow rate of the supplied water. Accordingly, the digital faucet system 1000 may have an excellent appearance since the digital faucet system 1000 may automatically adjust the temperature and the flow rate (i.e., amount of water per unit time) based on the temperature input data and the flow rate input data.

FIG. 6 is a block diagram illustrating a digital faucet system according to some example embodiments.

Referring to FIG. 6, a digital faucet system 1000 includes a faucet 1100, a data input unit 1200, a control unit 1300, a sense unit 1400 and an adjusting unit 1500.

The data input unit 1200 may include a display panel 1210 and a driver integrated circuit (IC) 1220. The display panel 1210 includes image pixels for displaying an image based on voltages provided from the driver IC 1220. The data input unit 1200 may further include a touch screen having touch screen sensor cells for detecting a touch of a user's hand or a touch pen. In some embodiments, the touch screen may be formed on the display panel 1210. In other embodiments, the display panel 1210 and the touch screen are formed in substantially the same plane in a manner such that touch screen sensors, which may include thin film transistors, are formed in image pixels. In some embodiments, the display panel 1210 may be a liquid crystal display panel, an organic light emitting display panel or a plasma display panel. The driver IC 1220 may apply voltages corresponding to image data provided from the control unit 1300 to the display panel 1210. The driver IC 1220 may receive a touch signal representing a vertical component and a horizontal component of a touch of a user's hand or a touch pen from the touch screen. The driver IC 1220 may convert the touch signal into a digital touch signal and provide the digital touch signal to the control unit 1300. The digital touch signal may include temperature input data and flow rate input data. For example, a horizontal component of the digital touch signal may correspond to the temperature input data, and a vertical component of the digital touch signal may correspond to the flow rate input data.

The control unit 1300 may control the adjusting unit 1500 based on the temperature input data and the flow rate input data received from the data input unit 1200. The control unit 1300 may receive temperature sensing data and flow rate sensing data from the sense unit 1400, and provide the data input unit 1200 with image data corresponding to the temperature sensing data and the flow rate sensing data. When actual temperature of water supplied through the faucet 1100 corresponding to the temperature sensing data is different from desired temperature corresponding to the temperature input data, the control unit 1300 may control the adjusting unit 1500 so as to adjust a ratio of hot water to cold water. When actual flow rate corresponding to the flow rate sensing data is different from desired flow rate corresponding to the flow rate input data, the control unit 1300 may control the adjusting unit 1500 so as to adjust amounts of the hot water and the cold water. In this case, the ratio of the hot water and the cold water may be maintained.

The sense unit 1400 may detect temperature and flow rate of mixed hot and cold water from an outlet of the faucet 1100. The flow rate corresponds to an amount of the water per unit time, and is referred to as intensity of the water. That is, the sense unit 1400 may detect the intensity of the water, or amount of the water per unit time. In some embodiments, the sense unit 1400 may include a hot water temperature sensor installed in a hot water path and a cold water temperature sensor installed in a cold water path. In other embodiments, the sense unit 1400 may include a mixed water temperature sensor installed in a mixed water path. In some embodiments, the sense unit 1400 may further include a hot water flow rate sensor installed in the hot water path and a cold water flow rate sensor installed in the cold water path. In other embodiments, the sense unit 1400 may include a mixed water flow rate sensor installed in the mixed water path.

The adjusting unit 1500 may adjust flow rates of the hot water, the cold water and/or the mixed water so that the mixed water from the faucet 1100 may have the temperature and the flow rate corresponding to the temperature input data and the flow rate input data. The adjusting unit 1500 may include a hot water adjusting motor installed in the hot water path for adjusting the flow rate of the hot water and a cold water adjusting motor installed in the cold water path for adjusting the flow rate of the cold water. Accordingly, the digital faucet system 1000 may automatically adjust the temperature and the flow rate of the mixed water by the hot water adjusting motor and the cold water adjusting motor that are installed in the hot water path and the cold water path, respectively.

The mixed water including the hot water and/or the cold water is provided to the user from the faucet 1100. The faucet 1100 may include the hot water path through which the hot water is supplied and the cold water path through which the cold water is supplied. The faucet 1100 may further include an outlet from which the mixed water may flow out. Here, the mixed water may be a tap water obtained by mixing the hot water supplied through the hot water path from the exterior and the cold water supplied through the cold water path form the exterior. A mixed water path may be a pipe through which the mixed water flows. The mixed water path may be connected to both of the hot water path and the cold water path, and may provide the outlet of the mixed hot and cold water supplied from the hot water path and the cold water path. The mixed water may include the hot water and the cold water. In some cases, the mixed water may include only the hot water if the user sets the temperature to the highest value, and the mixed water may include only the cold water if the user sets the temperature to the lowest value.

Hereinafter, operations of the digital faucet system 1000 according to some example embodiments will be described with reference to FIG. 6.

A user may turn on the digital faucet system 1000 b_{y} using the data input unit 1200. For example, the user may double-click the touch screen formed on/in the display panel 1210 to turn on the digital faucet system 1000. In some embodiments, the data input unit 1200 may further include an on/off button, and the user may press the on/off button to turn on the digital faucet system 1000.

When the digital faucet system 1000 is turned on, mixed water including hot water and/or cold water is supplied through the faucet 1100. In some embodiments, temperature and flow rate of the mixed water supplied when the digital faucet system 1000 is turned on may be the same as temperature and flow rate of the mixed water supplied when the digital faucet system 1000 is previously turned off. In other embodiments, the digital faucet system 1000 may not supply the mixed water until the user sets desired temperature and desired flow rate through the data input unit 1200.

When the mixed water is supplied through the faucet 1100, the sense unit 1400 may detect the temperature and the flow rate of the mixed water. The sense unit 1400 may provide the temperature sensing data and the flow rate sensing data to the control unit 1300. The control unit 1300 may generate the image data based on the temperature sensing data and the flow rate sensing data, and provide the image data to the data input unit 1200. The data input unit 1200 may display an image based on the image data.

The user may be aware of the temperature and the flow rate of the currently supplied mixed water from the image displayed by the data input unit 1200. If the image represents undesired temperature or undesired flow rate, the user may input new data into the data input unit 1200 to reset new temperature and new flow rate of the mixed water. The data input unit 1200 may generate the temperature input data and the flow rate input data based on the user's input, and provide the temperature input data and the flow rate input data to the control unit 1300.

The control unit 1300 may control the adjusting unit 1500 to adjust the flow rate of the hot water (i.e., the intensity of the hot water) and the flow rate of the cold water (i.e., the intensity of the cold water) based on the temperature input data and the flow rate input data. If the user changes only the temperature, the adjusting unit 1500 may adjust a ratio of the flow rate of the hot water to the flow rate of the cold water while the adjusting unit 1500 maintains a total flow rate of the hot water and the cold water (i.e., the flow rate of the mixed water). If the user changes only the flow rate, the adjusting unit 1500 may adjust the total flow rate of the hot water and the cold water while the adjusting unit 1500 maintains the ratio of the flow rate of the hot water to the flow rate of the cold water. If the user changes the temperature and the flow rate, the adjusting unit 1500 may adjust the ratio and the total flow rate.

The sense unit 1400 may continuously or periodically detect the temperature and the flow rate. When the temperature or the flow rate suddenly changes, the control unit 1300 may control the data input unit 1200 to display the changed temperature or flow rate, and control the adjusting unit 1500 to adjust the temperature and/or the flow rate to set corresponding values.

As described above, the digital faucet system 1000 according to some example embodiments may supply the mixed water of which temperature and flow rate are set through the data input unit 1200 by the user. Accordingly, the digital faucet system 1000 may supply the mixed water having desired temperature and desired flow rate that are set by the user's one-click. Further, the digital faucet system 1000 may have an excellent appearance since the digital faucet system 1000 includes the data input unit 1200 provided with the touch screen.

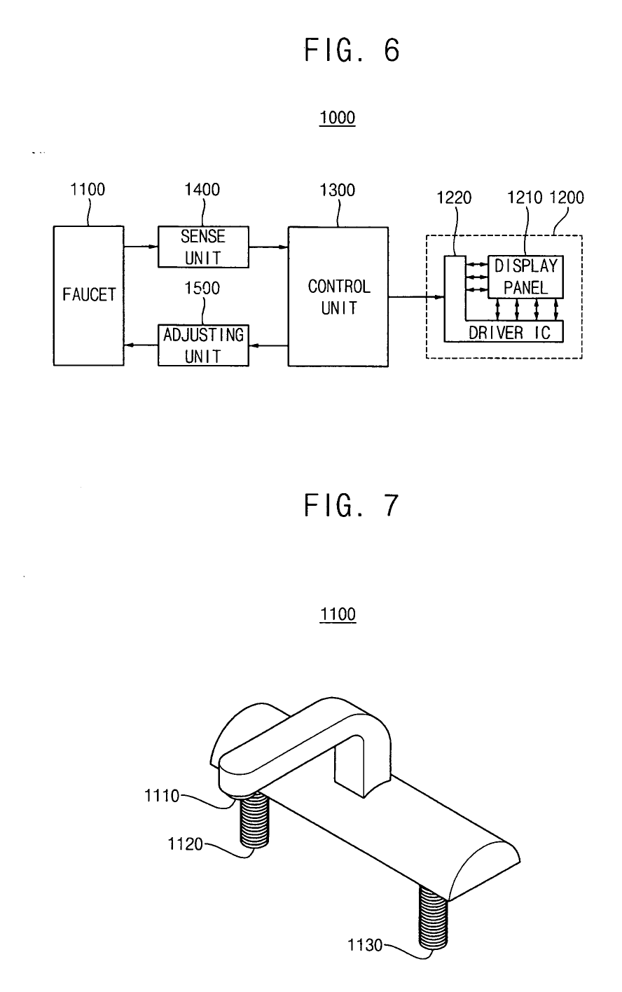

FIG. 7 is a diagram illustrating a faucet included in the digital faucet system 1000 of FIG. 5.

Referring to FIG. 7, a faucet 1100 includes an outlet 1110, a hot water path 1120 and a cold water path 1130.

The outlet 1110 including a hole that flows out hot water supplied through the hot water path 1120 and/or cold water supplied through the cold water path 1130. The mixed hot and cold water are provided by the outlet 1110. In some cases, the provided mixed water may be either the hot water or the cold water. The hot water path 1120 is a pipe through which the hot water is supplied, and the cold water path 1130 is a pipe through which the cold water is supplied. The hot water path 1120 and the cold water path 1130 are coupled in the faucet 1100. The faucet 1100 may further include a mixed water path from a position at which the hot water path 1120 and the cold water path 1130 are coupled to the outlet 1110. The mixed water including the hot water and/or the cold water flows through the mixed water path to the outlet 1110. It will be understood by a person skilled in the art that the faucet 1100 may have various shapes, and that the faucet 1100 may be installed in various environments, such as a bathtub, a sink, a washstand, etc.

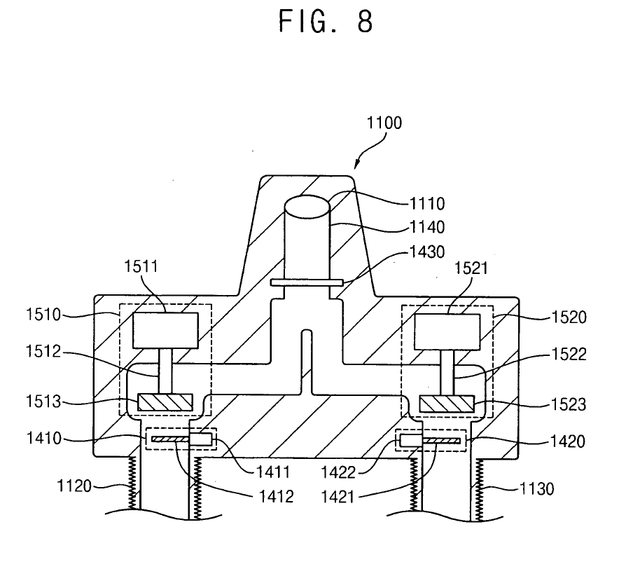

FIG. 8 is a cross-sectional view of the faucet of FIG. 5.

Referring to FIG. 8, the faucet 1100 includes an outlet 1110, a hot water path 1120, a cold water path 1130 and a mixed water path 1140. A hot water temperature sensor 1410 is installed in the hot water path 1120, and a cold water temperature sensor 1420 is installed in the cold water path 1130. A hot water adjusting unit 1510 is installed in the hot water path 1120, and a cold water adjusting unit 1520 is installed in the cold water path 1130. A mixed water flow rate sensor 1430 is installed in the mixed water path 1140.

The hot water temperature sensor 1410 may generate hot water temperature sensing data by detecting temperature of hot water that flows through the hot water path 1120, and may transfer the hot water temperature sensing data to the control unit 1300 illustrated in FIG. 6. The hot water temperature sensor 1410 may include a first water temperature probe 1411 and a first water temperature connector 1412. The first water temperature probe 1411 may include a variable resistor of which resistance changes depending on the temperature. The first water temperature connector 1412 may connect the first water temperature probe 1411 to the control unit 1300. In some embodiments, the control unit 1300 may apply a test current or a test voltage to the hot water temperature sensor 1410, and receive the hot water temperature sensing data about the temperature of the hot water by measuring an output current or an output voltage from the hot water temperature sensor 1410.

The cold water temperature sensor 1420 may generate cold water temperature sensing data by detecting temperature of cold water that flows through the cold water path 1130, and may transfer the cold water temperature sensing data to the control unit 1300 illustrated in FIG. 6. The cold water temperature sensor 1420 may include a second water temperature probe 1421 and a second water temperature connector 1422. The second water temperature probe 1421 may include a variable resistor of which resistance changes depending on the temperature. The second water temperature connector 1422 may connect the second water temperature probe 1421 to the control unit 1300. In some embodiments, the control unit 1300 may apply a test current or a test voltage to the cold water temperature sensor 1420, and receive the cold water temperature sensing data about the temperature of the cold water by measuring an output current or an output voltage from the cold water temperature sensor 1420.

The control unit 1300 may calculate the temperature of mixed water based on the hot water temperature sensing data from the hot water temperature sensor 1410, the cold water temperature sensing data from the cold water temperature sensor 1420, and a ratio of flow rate of the hot water to flow rate of the cold water.

Alternatively, the faucet 1100 may include a mixed water temperature sensor instead of the hot water temperature sensor 1410 and the cold water temperature sensor 1420. The control unit 1300 may measure the temperature of mixed water based on mixed water temperature sensing data received from the mixed water temperature sensor.

The control unit 1300 may receive the hot water temperature sensing data and the cold water temperature sensing data as temperature sensing data, or receive the mixed water temperature sensing data as the temperature sensing data. When the hot water temperature sensor 1410 and the cold water temperature sensor 1420 are installed in the faucet 1100, each temperature change of the hot water and the cold water is respectively sensed. When only the mixed water temperature sensor is installed in the faucet 1100, the number of temperature sensors may be reduced.

The mixed water flow rate sensor 1430 detects a flow rate of the mixed water flowing through the mixed water path 1140, and transfers mixed water flow rate sensing data to the control unit 1300 illustrated in FIG. 6. The control unit 1300 may receive the mixed water flow rate sensing data as flow rate sensing data. The control unit 1300 may measure flow rate of the mixed water based on the mixed water temperature sensing data.

Alternatively, the faucet 1100 may include a hot water flow rate sensor and a cold water flow rate sensor instead of the mixed water flow rate sensor 1430. The control unit 1300 may receive hot water flow rate sensing data from the hot water flow rate sensor and cold water flow rate sensing data from the cold water flow rate sensor as the flow rate sensing data. The control unit 1300 may calculate the flow rate of the mixed water based on the hot water flow rate sensing data and the cold water flow rate sensing data.

When the hot water flow rate sensor and the cold water flow rate sensor are installed in the faucet 1100, each flow rate change of the hot water and the cold water is respectively sensed. When only the mixed water flow rate sensor 1430 is installed in the faucet 1100, the number of flow rate sensors may be reduced.

The hot water adjusting unit 1510 is controlled by the control unit 1300 illustrated in FIG. 6 to adjust the flow rate of the hot water flowing through the hot water path 1120. The hot water adjusting unit 1510 may include a first adjusting motor 1511, a first connecting rod 1512, and a first washer 1513. The first adjusting motor 1511 may convert provided electric power into mechanical power. The first adjusting motor 1511 may be a DC motor, a step motor, a servo motor, and the like. The first connecting rod 1512 may connect the first adjusting motor 1511 to the first washer 1513 to transfer the mechanical power supplied from the first adjusting motor 1511 to the first washer 1513. The first washer 1513 may vertically move to adjust the flow rate of the hot water supplied through the hot water path 1120. For example, as mechanical force of the first adjusting motor 1511 moves the first washer 1513 up, the intensity of the hot water may increase. As the mechanical force moves the first washer 1513 down, the intensity of the hot water may decrease. In other examples, the first washer 1513 may rotate to adjust the flow rate of the hot water supplied through the hot water path 1120.

The hot water adjusting unit 1510 may further include a link unit coupled between the first adjusting motor 1511 and the first connecting rod 1512, or between the first connecting rod 1512 and the first washer 1513. The link unit may convert a rotary force of the first adjusting motor 1511 into a straight-line force to move the first washer 1513 up and down. The link unit may include at least one gear.

The cold water adjusting unit 1520 is controlled by the control unit 1300 illustrated in FIG. 6 to adjust the flow rate of the cold water flowing through the cold water path 1130. The cold water adjusting unit 1520 may include a second adjusting motor 1521, a second connecting rod 1522 and a second washer 1523. The second adjusting motor 1521 may convert provided electric power into mechanical power. The second adjusting motor 1521 may be a DC motor, a step motor, a servo motor, and the like. The second connecting rod 1522 may connect the second adjusting motor 1521 to the second washer 1523 to transfer the mechanical power supplied from the second adjusting motor 1521 to the second washer 1523. The second washer 1523 may vertically move to adjust the flow rate of the cold water supplied through the cold water path 1130. For example, as mechanical force of the second adjusting motor 1521 moves the second washer 1523 up, the intensity of the cold water may increase. As the mechanical force moves the second washer 1523 down, the intensity of the cold water may decrease. In other examples, the second washer 1523 may rotate to adjust the flow rate of the cold water supplied through the cold water path 1130.

The cold water adjusting unit 1520 may further include a link unit coupled between the second adjusting motor 1521 and the second connecting rod 1522, or between the second connecting rod 1522 and the second washer 1523. The link unit may convert a rotary force of the second adjusting motor 1521 into a straight-line force to move the second washer 1523 up and down. The link unit may include at least one gear.

A digital faucet system according to some example embodiments includes the hot water adjusting unit 1510 and the cold water adjusting unit 1520 for respectively adjusting the intensity of the hot water and the intensity of the cold water. Accordingly, a ratio of the intensity of the hot water to that of the cold water as well as a total flow rate of the hot water and the cold water may be automatically adjusted.

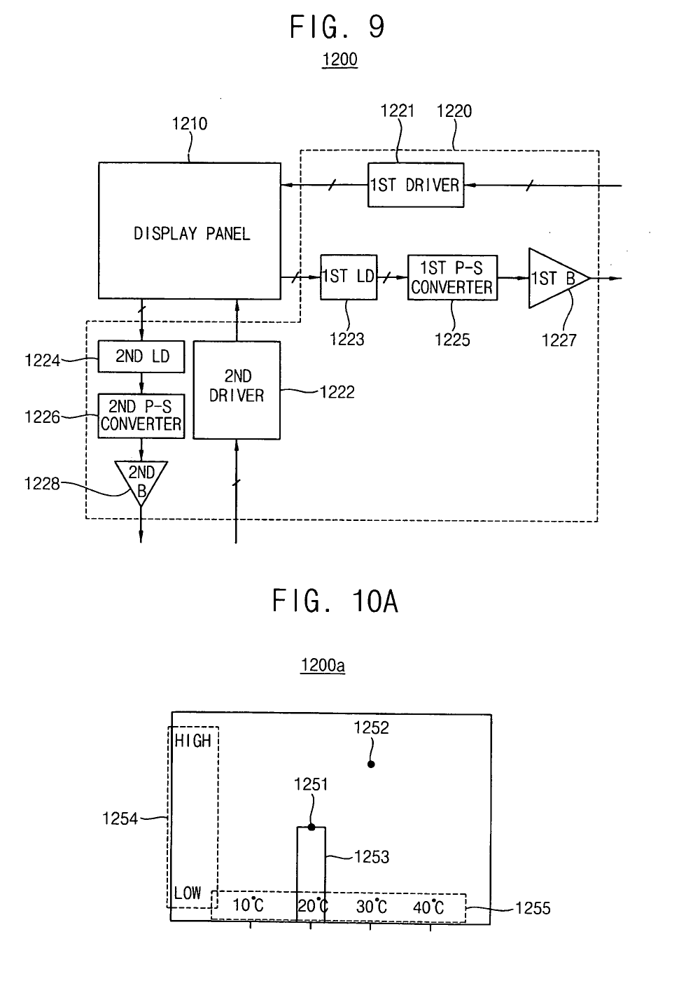

FIG. 9 is a block diagram illustrating a data input unit included in the digital faucet system of FIG. 5.

Referring to FIG. 9, the data input unit 1200 includes a display panel 1210 and a driver integrated circuit (IC) 1220. The driver IC 1220 includes a first driver 1221, a second driver 1222, a first level detector 1223, a first parallel-serial converter 1225, a first buffer 1227, a second level detector 1224, a second parallel-serial converter 1226, and a second buffer 1228.

The display panel 1210 displays an image in response to driving signals applied from the first driver 1221 and the second driver 1222. The display panel 1210 may include touch screen sensors embedded therein or formed on its surface. The display panel 1210 transmits analog touch signals to the first level detector 1223 and the second level detector 1224 by detecting a touch of a user by the touch screen sensors.

The first driver 1221 may include a gate driver for turning on/off thin film transistors disposed in the display panel 1210 in response to image control signals. The second driver 1222 may include a source driver for applying voltages corresponding to image data to the display panel 1210 in response to the image control signals. The first driver 1221 and the second driver 1222 may drive the display panel 1210 to display the image corresponding to the image data provided from a control unit 1300 illustrated in FIG. 6.

The first level detector 1223 receives the analog touch signals from the touch screen sensors. The first level detector 1223 may receive the analog touch signals representing a vertical component of a point where the user touches the display panel 1210. The first level detector 1223 may convert the analog touch signals into digital touch signals based on reference voltages. The first level detector 1223 may discharge the touch screen sensors in response to a reset signal so as to initialize the touch screen sensors. The first parallel-serial converter 1225 may receive the digital touch signals applied in parallel from the first level detector 1223. The first parallel-serial converter 1225 may convert the digital touch signals into serial signals. The first parallel-serial converter 1225 may store the digital touch signals in response to a load signal, and performs shift operations in response to a shift clock signal to output the serial digital touch signal. The first buffer 1227 may be an output driver circuit for maintaining an output level of the serial digital touch signal at a logic high level of a lock low level. The first buffer 1227 may include a CMOS inverter.

The second level detector 1224, the second parallel-serial converter 1226 and the second buffer 1228 may operate similarly to the first level detector 1223, first parallel-serial converter 1225 and the first buffer 1227. The second level detector 1224, the second parallel-serial converter 1226 and the second buffer 1228 may provide the control unit 1300 illustrated in FIG. 6 with information about a horizontal component of the point where the user touches the display panel 1210.

In some embodiments, the display panel 1210 may be a liquid crystal display panel, an organic light emitting display panel or a plasma display panel. The driver IC 1220 may be implemented as one chip or as two or more chips. It will be understood by a person skilled in the art that the number of drivers, the number of level detectors, the number of parallel-serial converters, and the number of buffers vary depending on the application of the present invention.

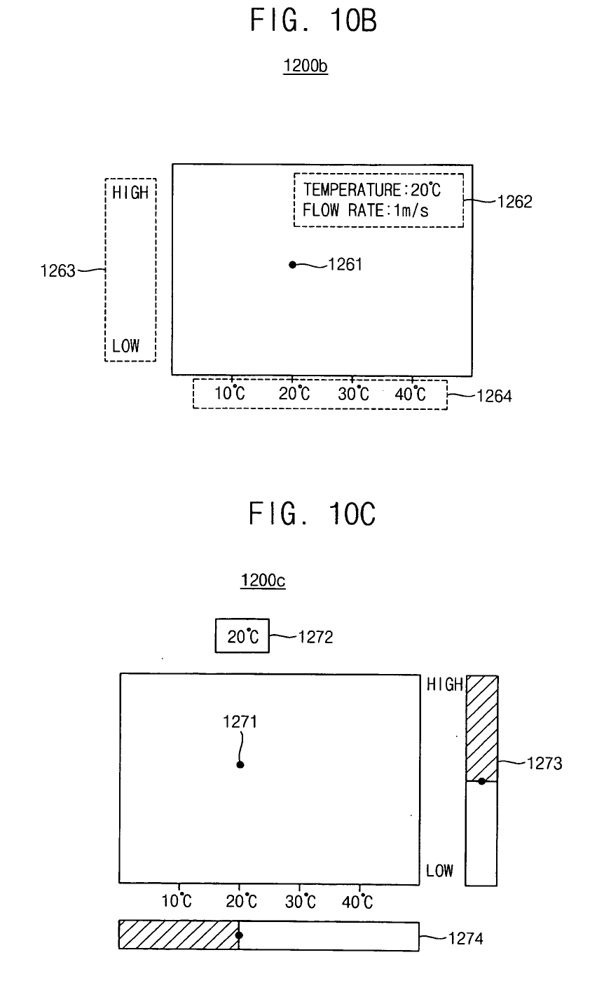

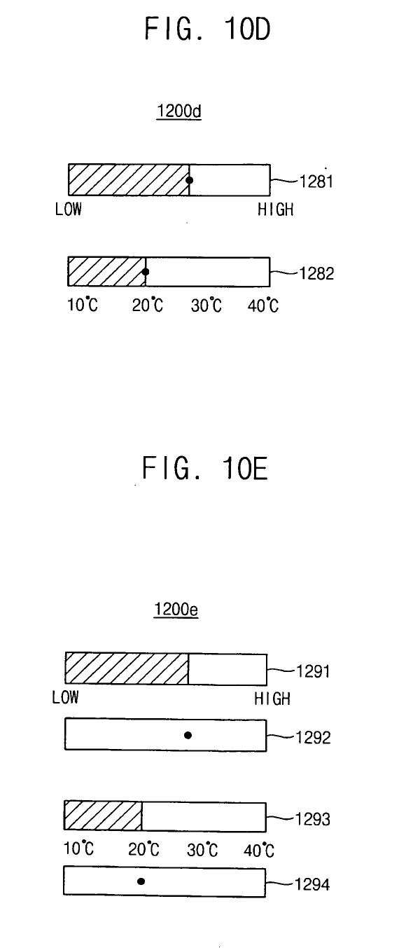

FIGS. 10A through 10E are diagrams illustrating appearances of examples of a data input unit included in the digital faucet system of FIG. 5.

Referring to FIG. 10A, a data input unit 1200a has a two dimensional plane shape. The data input unit 1200a displays temperature and flow rate of water currently supplied from the digital faucet system 1000. For example, the data input unit 1200a may display a status bar 1253 representing the temperature and the flow rate of the currently supplied water. In other embodiments, the data input unit 1200a may display the temperature and the flow rate in a form of a point 1251, a straight line, a curve or the like. The data input unit 1200a may further display flow rate graduations 1254 for the flow rate of the water (i.e., the intensity of the water, or amount of water supplied per unit time), and temperature graduations 1255 for the temperature of the water.

A user may click a position 1252 on the data input unit 1200a to change the temperature and the flow rate. A horizontal component of the position 1252 may correspond to the temperature to be set, and a vertical component of the position 1252 may correspond to the intensity to be set. Thus, the temperature and the flow rate may be simultaneously set by the user's one-click. When the user clicks the position 1252, the data input unit 1200a may display a mark having a shape, such as circle, star, V, point, etc., at the position 1252. The digital faucet system 1000 may supply the water having the desired temperature and the desired flow rate corresponding to the position 1252.

Referring to FIG. 10B, a data input unit 1200b displays a status point 1261 representing the temperature and the flow rate of the currently supplied water. The data input unit 1200b may further display the temperature and the flow rate in numbers on a portion 1262 of a display panel. Flow rate graduations 1263 and temperature graduations 1264 may be printed on the exterior of a display panel.

Referring to FIG. 10C, a data input unit 1200c includes a display panel for displaying the temperature and the flow rate of the currently supplied water and generating the temperature input data and the flow rate input data by detecting the user's touch. The data input unit 1200c may further include a temperature display panel 1272, a flow rate input and display panel 1273 and a temperature input and display panel 1274. The temperature display panel 1272 may display the current temperature in numbers. The flow rate input and display panel 1273 may display the current flow rate in a form of a bar, and generate the flow rate input data by detecting the user's touch. The temperature input and display panel 1274 may display the current temperature in a form of a bar, and generate the temperature input data by detecting the user's touch.

Referring to FIG. 10D, a data input unit 1200d includes a flow rate input and display panel 1281 and a temperature input and display panel 1282. The flow rate input and display panel 1281 may display the current flow rate in a form of a bar, and generate the flow rate input data by detecting the user's touch. The temperature input and display panel 1282 may display the current temperature in a form of a bar, and generate the temperature input data by detecting the user's touch.

Referring to FIG. 10E, a data input unit 1200e includes a flow rate display panel 1291, a flow rate input panel 1292, a temperature display panel 1293 and a temperature input panel 1294. The flow rate display panel 1291 may display the current flow rate in a form of a bar. The flow rate input panel 1292 may generate the flow rate input data by detecting the user's touch. The temperature display panel 1293 may display the current temperature in a form of a bar. The temperature input panel 1294 may generate the temperature input data by detecting the user's touch.

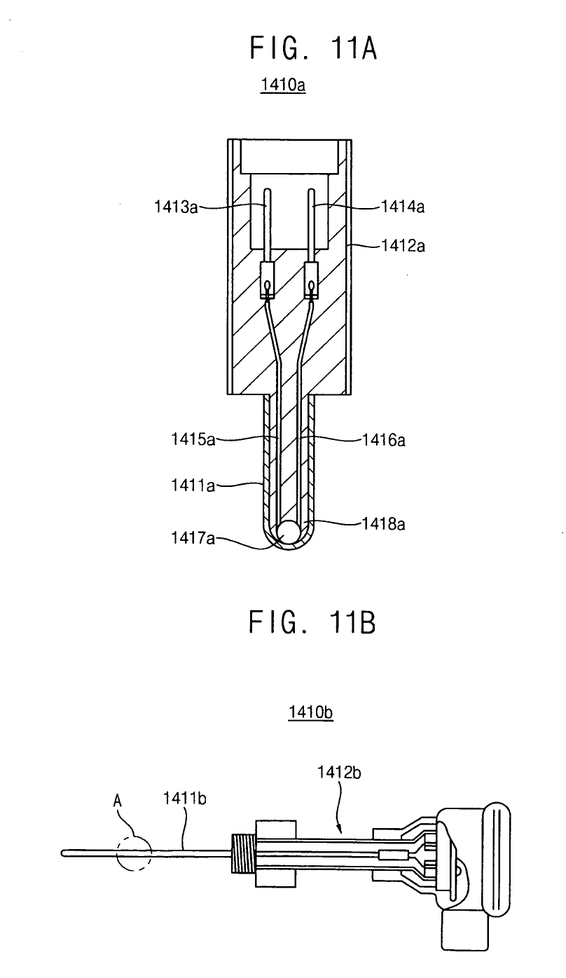

FIGS. 11A through 11C are diagrams illustrating examples of a temperature sensor included in the digital faucet system of FIG. 5.

Referring to FIG. 11A, a temperature sensor 1410a includes a temperature probe 1411a and a temperature connector 1412a.

The temperature probe 1411 a may include a thermistor 1417a embedded therein. In some embodiments, the temperature probe 1411 a may be installed in each of a hot water path and a cold water path. In other embodiments, the temperature probe 1411a may be installed in a mixed water path.

The temperature connector 1412a may include wires 1415a and 1416a extended from terminals 1413a and 1414a to the interior of the temperature probe 1411a. The thermistor 1417a included in the temperature probe 1411a is connected to the wires 1415a and 1416a.

The temperature connector 1412a may be integrally formed with the temperature probe 1411a. For example, the thermistor 1417a, the wires 1415a and 1416a and the temperature connector 1412a may be molded and fixed with plastic material.

The temperature sensor 1410a may generate temperature sensing data by using the thermistor 1417a of which resistance decreases as the temperature increases. The temperature sensing data may be transferred through the temperature connector 1412a to the control unit 1300 illustrated in FIG. 6.

Referring to FIGS. 11B and 11C, a temperature sensor 1410b includes a temperature probe 1411 b and a temperature connector 1412b.

The temperature sensor 1410b may be a metal sheathed thermocouple temperature sensor. In the metal sheathed thermocouple temperature sensor, thermocouple wires may be mounted in a stainless steel or an inconel sheath, and are electrically insulated with mineral oxides.

The temperature sensor 1410b may include a thermocouple wire 1419b, an oxide 1421b and a sheath 1422b. The temperature sensor 1410b may sense the temperature by detecting currents generated by a thermoelectric power by the thermocouple wire 1419b.

The temperature connector 1412b may be integrally formed with the temperature probe 1411b. The temperature connector 1412b may transfer the temperature sensing data to the control unit 1300 illustrated in FIG. 6.

While two examples of the temperature sensor are illustrated in FIG. 11A through 11C, it will be understood by a person skilled in the art that the temperature sensor may have various types.

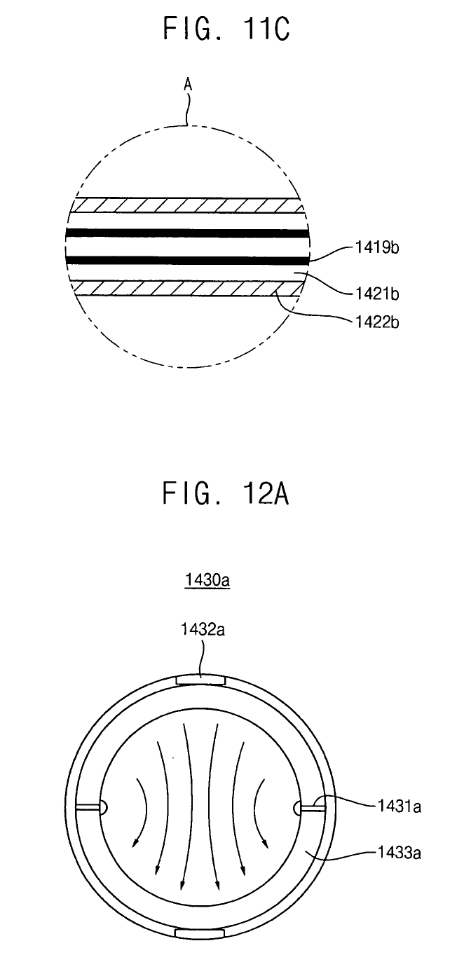

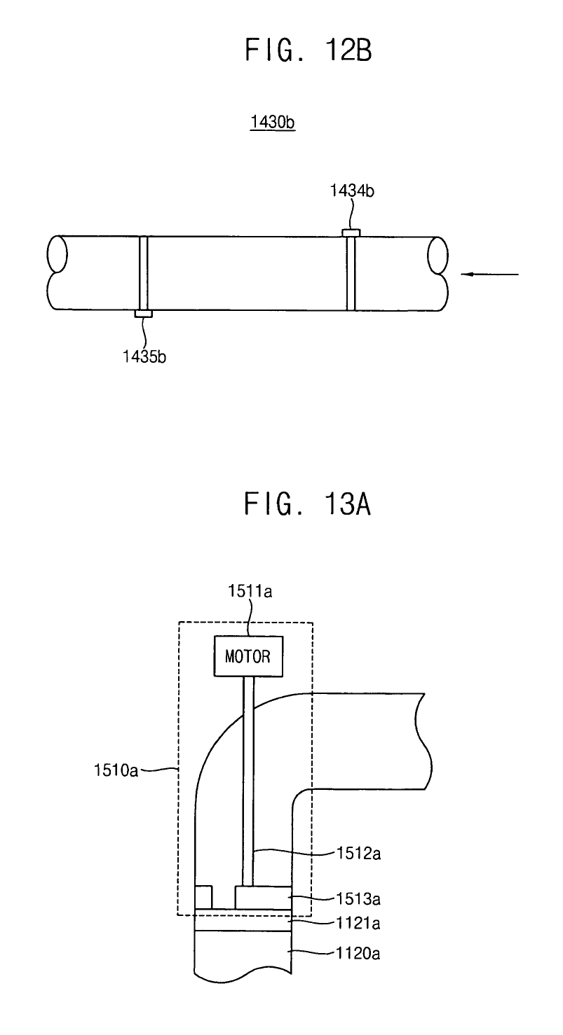

FIGS. 12A and 12B are diagrams illustrating examples of a flow rate sensor included in the digital faucet system of FIG. 5.

In some embodiments, a flow rate sensor may be installed in each of a hot water path and a cold water path. In other embodiments, the flow rate sensor may be installed in a mixed water path.

Referring to FIG. 12A, a flow rate sensor 1430a includes electromagnets 1432a and electromotive force (EMF) sensors 1431a. The electromagnets 1432a may be formed on the outside of a pipe (e.g., a hot water path, a cold water path or a mixed water path) 1433a facing each other. The EMF sensors 1431a may be formed on the inside of the pipe 1433a facing each other.

The flow rate sensor 1430a may sense a flow rate by detecting the EMF generated by magnetic flux and moving fluid. The electromagnets 1432a may generate magnetic flux in a direction perpendicular to the moving fluid. The EMF may be induced by the magnetic flux and the moving fluid in a direction perpendicular to the magnetic flux and the moving fluid. The EMF may increase as the flow rate of the fluid increases. The EMF sensors 1431a may measure the EMF, and thus the flow rate sensor 1430a may generate flow rate data based on the measured EMF. Further, since the size of the cross section of the pipe 1433a may be known, the amount of the water flowing per unit time may be calculated based on the flow rate and the size of the cross section. The flow rate sensor 1430a may transfer the flow rate data to the control unit 1300 illustrated in FIG. 6.

Referring to FIG. 12B, a flow rate sensor 1430b includes acoustic wave sensors 1434b and 1435b. The acoustic wave sensors 1434b and 1435b may be formed on the outside of a pipe (e.g., a hot water path, a cold water path or a mixed water path) vertically facing each other.

The flow rate sensor 1430b may sense flow rate of a fluid by using an acoustic wave of which wavelength changes depending on the flow rate. The acoustic wave sensors 1434b and 1435b may detect the acoustic wave. The wavelength may be calculated based on time difference between time points when the acoustic wave is detected by the acoustic wave sensors 1434b and 1435b, respectively. As the flow rate increases, the wavelength may decrease. The flow rate sensor 1430b may generate flow rate data based on the measured wavelength. The flow rate sensor 1430b may transfer the flow rate data to the control unit 1300 illustrated in FIG. 6.

While two examples of the flow rate sensor are illustrated in FIGS. 12A and 12B, it will be understood by a person skilled in the art that the flow rate sensor may have various types.

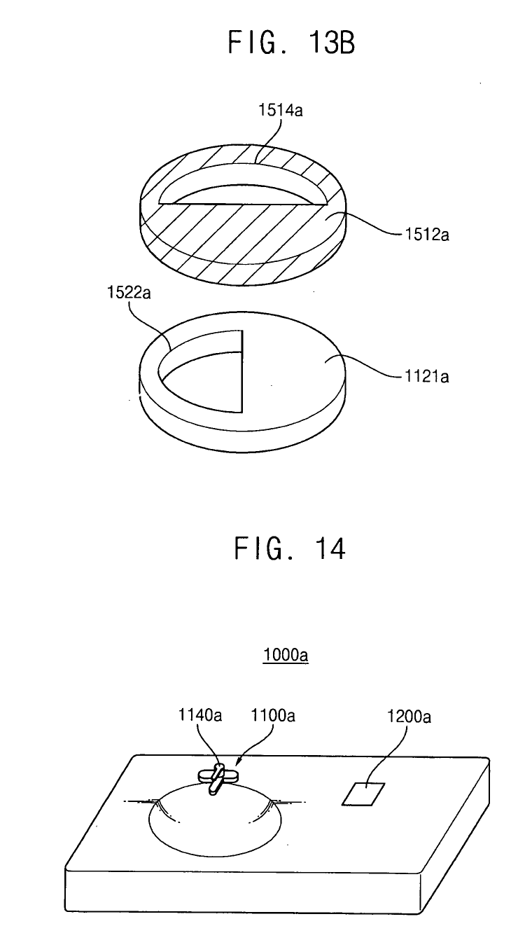

FIGS. 13A and 13B are diagrams illustrating an example of an adjusting unit included in the digital faucet system of FIG. 5.

In FIGS. 13A and 13B, an example of a hot water adjusting unit 1510a is illustrated. The example of the hot water adjusting unit 1510a illustrated in FIGS. 13A and 13B may operate in a different manner from that of an example of a hot water adjusting unit 1510 illustrated in FIG. 8.

Referring to FIGS. 13A and 13B, the hot water adjusting unit 1510a includes an adjusting motor 1511a, a connecting rod 1512a and an adjusting plate 1513a. A fixed plate 1121a is installed in a hot water path 1120a.

The adjusting motor 1511a may convert electric power into mechanical power. The adjusting motor 1511a may be a DC motor, a step motor, a servo motor, and the like. The connecting rod 1512a may connect the adjusting motor 1511a to the adjusting plate 1513a to transfer the mechanical power supplied from the adjusting motor 1511a to the adjusting plate 1513a. The adjusting plate 1513a includes an adjusting opening 1514a, and the fixed plate 1121a includes a fixed opening 1522a. As the adjusting plate 1513a rotates, an overlapped region between the adjusting opening 1514a and the fixed opening 1522a may change. The flow rate of the hot water may be adjusted by the size of the overlapped region. For example, when the adjusting opening 1514a fully overlaps the fixed opening 1522a, the flow rate of the hot water may be the maximum rate. When the adjusting opening 1514a does not overlap the fixed opening 1522a, the hot water may not be supplied.

While two examples of the adjusting unit are illustrated in FIGS. 8, 12A and 12B, it will be understood by a person skilled in the art that the adjusting unit may have various structures.

FIG. 14 is a diagram illustrating an appearance of a digital faucet system according to some example embodiments.

Referring to FIG. 14, a digital faucet system 1000a includes a faucet 1100a and a data input unit 1200a. The digital faucet system 1000a may further include a handle 1140a or a lever for manually adjusting temperature and flow rate.

In an emergency situation, a user may manually adjust the temperature and the flow rate by using the handle 1140a or the lever. For example, the user may use the handle 1140a when the digital faucet system 1000a is out of order. In some embodiments, when the user sets the temperature and the flow rate by using the data input unit 1200a, the digital faucet system 1000a may move the handle 1140a based on the temperature and the flow rate set by the user.

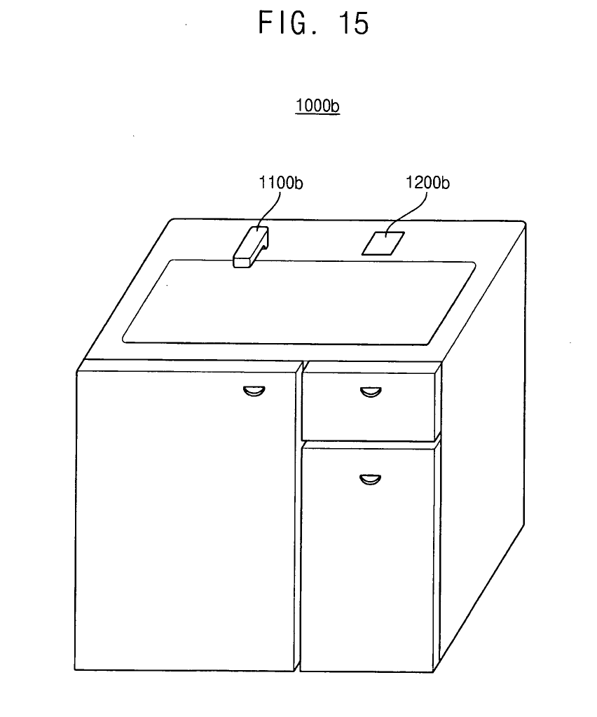

FIG. 15 is a diagram illustrating an appearance of a digital faucet system according to some example embodiments.

Referring to FIG. 15, a digital faucet system 1000b includes a faucet 1100b and a data input unit 1200b.

The digital faucet system 1000b may be installed in a sink. A user may set desired temperature and desired flow rate by one-click. The digital faucet system 1000b applied to the sink may have an excellent appearance.

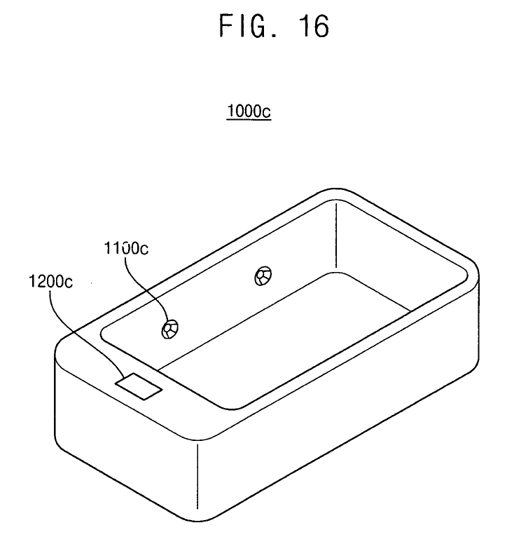

FIG. 16 is a diagram illustrating an appearance of a digital faucet system according to some example embodiments.

Referring to FIG. 16, a digital faucet system 1000c includes a faucet 1100c and a data input unit 1200c.

The digital faucet system 1000c may be installed in a bathtub. The faucet 1100c may have an outlet embedded in the bathtub. The digital faucet system 1000c may further include a shower where water is supplied. The temperature and the flow rate of the water are automatically adjusted by the digital faucet system 1000c. The digital faucet system 1000c applied to the bathtub may have an excellent appearance.

As described above, the digital faucet system according to some example embodiments may automatically adjust temperature and flow rate of water based on temperature input data and flow rate input data input by a data input unit. Further, the digital faucet system according to some example embodiments may have an excellent appearance.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A digital faucet system, comprising:
a faucet coupled to a hot water path and a cold water path, and configured to output mixed water including hot water provided from the hot water path and cold water provided from the cold water path;
a data input unit including a display panel for displaying a temperature and a flow rate of the mixed water, and a touch screen for generating temperature input data and flow rate input data;
a sense unit configured to generate temperature sensing data and flow rate sensing data by detecting the temperature and the flow rate of the mixed water;
an adjusting unit configured to adjust the temperature and the flow rate of the mixed water; and
a control unit configured to control the adjusting unit to adjust the temperature and the flow rate of the mixed water based on the temperature input data, the flow rate input data, the temperature sensing data and the flow rate sensing data.

2. The digital faucet system of claim 1, wherein the adjusting unit comprises:
a hot water adjusting unit configured to adjust a flow rate of the hot water; and
a cold water adjusting unit configured to adjust a flow rate of the cold water.

3. The digital faucet system of claim 2, wherein the control unit controls the hot water adjusting unit and the cold water adjusting unit to adjust a ratio of the flow rate of the hot water to the flow rate of the cold water while the flow rate of the mixed water is maintained, when a temperature corresponding to the temperature input data is different from a temperature corresponding to the temperature sensing data.

4. The digital faucet system of claim 2, wherein the control unit controls the hot water adjusting unit and the cold water adjusting unit to adjust the flow rate of the hot water and the flow rate of the cold water while a ratio of the flow rate of the hot water to the flow rate of the cold water is maintained, when a flow rate corresponding to the flow rate input data is different from a flow rate corresponding to the flow rate sensing data.

5. The digital faucet system of claim 1, wherein the control unit provides image data corresponding to the temperature sensing data and the flow rate sensing data to the data input unit, and the data input unit displays an image based on the image data.

6. The digital faucet system of claim 5, wherein the image displayed by the data input unit includes information about the temperature and the flow rate of the mixed water supplied by the faucet.

7. The digital faucet system of claim 1, wherein the touch screen generates the temperature input data and the flow rate input data by detecting a single touch point.

8. A digital faucet system, comprising:
a faucet coupled to a hot water path and a cold water path, and configured to output mixed water including hot water provided from the hot water path and cold water provided from the cold water path;
a data input unit configured to generate temperature input data and flow rate input data;
an adjusting unit configured to adjust a temperature and a flow rate of the mixed water; and
a control unit configured to control the adjusting unit to adjust the temperature and the flow rate of the mixed water based on the temperature input data and the flow rate input data.

9. The digital faucet system of claim 8, wherein the data input unit comprises a touch screen for detecting a touch point indicating a temperature and a flow rate of the mixed water to be set.

10. The digital faucet system of claim 8, wherein the data input unit comprises:
a panel including image pixels for displaying an image that represents the temperature and the flow rate of the mixed water and touch screen sensors for detecting a touch point indicating a temperature and a flow rate of the mixed water to be set; and
a driver integrated circuit configured to drive the panel by applying voltages corresponding to image data provided from the control unit to the image pixels, configured to generate the temperature input data and the flow rate input data based on a detection result from the touch screen sensors, and configured to provide the temperature input data and the flow rate input data to the control unit.

11. The digital faucet system of claim 8, wherein the adjusting unit comprises:
a hot water adjusting unit configured to adjust a flow rate of the hot water; and
a cold water adjusting unit configured to adjust a flow rate of the cold water.

12. The digital faucet system of claim 11, wherein the hot water adjusting unit and the cold water adjusting unit adjust a ratio of the flow rate of the hot water to the flow rate of the cold water so as to adjust the temperature of the mixed water.

13. The digital faucet system of claim 11, wherein the hot water adjusting unit and the cold water adjusting unit adjust the flow rate of the hot water and the flow rate of the cold water and maintain a ratio of the flow rate of the hot water to the flow rate of the cold water so as to adjust the flow rate of the mixed water.

14. The digital faucet system of claim 8, further comprising:
a sense unit configured to generate temperature sensing data and flow rate sensing data by detecting the temperature and the flow rate of the mixed water, and provide the temperature sensing data and the flow rate sensing data to the control unit.

15. The digital faucet system of claim 14, wherein the control unit provides image data corresponding to the temperature sensing data and the flow rate sensing data, and the data input unit displays an image based on the image data.

16. The digital faucet system of claim 14, wherein the control unit controls the adjusting unit to adjust the temperature of the mixed water when a temperature corresponding to the temperature input data is different from a temperature corresponding to the temperature sensing data, and
wherein the control unit controls the adjusting unit to adjust the flow rate of the mixed water when a flow rate corresponding to the flow rate input data is different from a flow rate corresponding to the flow rate sensing data.

17. The digital faucet system of claim 14, wherein the adjusting unit comprises a hot water adjusting unit for adjusting a flow rate of the hot water and a cold water adjusting unit for adjusting a flow rate of the cold water,
wherein the control unit controls the hot water adjusting unit and the cold water adjusting unit based on the temperature input data and the temperature sensing data to adjust a ratio of the flow rate of the hot water to the flow rate of the cold water, and
wherein the control unit controls the hot water adjusting unit and the cold water adjusting unit based on the flow rate input data and the flow rate sensing data to adjust the flow rate of the hot water and the flow rate of the cold water.

18. The digital faucet system of claim 14, wherein the sense unit comprises:
a mixed water temperature sensor installed in a mixed water path through which the mixed water flows, and configured to generate the temperature sensing data by detecting the temperature of the mixed water; and
a mixed water flow rate sensor installed in the mixed water path, and configured to generate the flow rate sensing data by detecting the flow rate of the mixed water.

19. The digital faucet system of claim 14, wherein the sense unit comprises:
a hot water temperature sensor installed in the hot water path, and configured to generate hot water temperature sensing data by detecting a temperature of the hot water;
a cold water temperature sensor installed in the cold water path, and configured to generate cold water temperature sensing data by detecting a temperature of the cold water;
a hot water flow rate sensor installed in the hot water path, and configured to generate hot water flow rate sensing data by detecting a flow rate of the hot water; and
a cold water flow rate sensor installed in the cold water path, and configured to generate cold water flow rate sensing data by detecting a flow rate of the cold water.
